(19) United States
(12) Patent Application Publication
(10) Pub. No.: US 2026/0106396 A1
(43) Pub. Date: Apr. 16, 2026

(54) CONNECTOR, CONNECTOR SYSTEM, AND CONNECTOR MATING METHOD

(71) Applicant: Okins electronics Co, Ltd., Ulwang-si (KR)

(72) Inventors: Seung Hyun NOH, Sacheon-si (KR); Jin Kook JUN, Gunpo-si (KR); Chan Ho LEE, Siheung-si (KR)

(73) Assignee: okins electronics Co.,Ltd, Uiwang-si (KR)

(21) Appl. No.: 19/354,871

(22) Filed: Oct. 10, 2025

(30) Foreign Application Priority Data
Oct. 10, 2024 (KR) 10-2024-0137851
Dec. 17, 2024 (KR) 10-2024-0188255

(51) Int. Cl. H01R 13/26; H01R 13/28; H01R 43/26

(52) U.S. Cl. CPC H01R 13/26; H01R 13/28; H01R 43/26

(57) ABSTRACT

Disclosed are a connector, a connector system, and a connector mating method, and more particularly a technology for, during mating between connectors, a plurality of parts of a terminal being bent by pressing of a terminal and a partition wall of a mating connector, thereby forming multiple contact points and a technology for selectively determining the type of the connector through the combination and arrangement relationship of lead frame assemblies.

### CROSS-REFERENCE TO THE RELATED APPLICATION

The present application claims priority to and the benefit of Korean Patent Application No. 10-2024-0137851, filed on Oct. 10, 2024, and Korean Patent Application No. 10-2024-0188255, filed on Dec. 17, 2024 in the Korean Intellectual Property Office, the entire disclosure of which is incorporated herein by reference.

### BACKGROUND

1. Field Embodiments of the present disclosure relate to a connector, a connector system, and a connector mating method, and more particularly to a technology for, during mating between connectors, bending a plurality of parts of a terminal by pressing of a terminal and a partition wall of a mating connector, thereby forming multiple contact points and a technology for selectively determining the type of the connector through the combination and arrangement relationship of lead frame assemblies.

### 2. Description of the Related Art

A board-to-board connector (a BtB connector) is mainly used to electrically connect circuit boards to each other. During coupling between the connectors, electrical connection between the connectors is achieved through alignment between terminals, enabling electrical signal transmission between boards.

By implementing multiple contact points between terminals during connector mating, contact failure between the terminals is eliminated, enhancing contact reliability and reducing signal transmission loss.

FIG. 1 shows a conventional dual contact point structure, and FIG. 2 shows a conventional connector mating process.

Conventionally, the end of a lead portion 15 of a terminal 10 is bent upward to form a contact point 11, and upon mating between connectors, the bent contact point 11 of the terminal 10 contacts a terminal of a mating connector, thereby implementing dual contact points.

The connector mating process will be described with reference to FIG. 2. As shown in FIG. 2A, when the terminal 10 contacts the terminal of the mating connector, the terminals push each other by the height B of the bent contact point 11, whereby a lead portion 15 of the terminal 10 is greatly bent, as shown in FIG. 2B.

When the ends of the terminals 10 pass over the bent contact points 11 of each other and mate with each other, the lead portion 15 of the terminal 10 may return to the original shape thereof, whereby dual contact points may be formed at two positions P1 and P2.

Due to the bent contact points 11, the lead portion 15 is greatly bent during mating between the connectors, and a core portion of the terminal 10 supported by a housing is subjected to severe stress proportional to the height B of the bent contact point 11, which causes deformation of the terminal 10 or breakage of the core portion that supports the terminal 10.

Furthermore, when mating and disconnection between the connectors are repeatedly performed, stress due to repeated pressing between the bent contact points 11 of the terminal 10 is continuously accumulated in the terminal 10. Consequently, the bent contact point 11 of the terminal 10 may be deformed, whereby the curvature thereof may be reduced. This may lead to a non-contact problem where the contact point 11 fails to make contact with the terminal of the mating connector.

In addition, conventional connectors require separate structural designs and individually manufactured components for each type: a plug connector, a receptacle connector, or a hermaphroditic connector.

Since the structure and components differ by connector type, manufacturing costs increase and there is a problem of lack of compatibility between parts.

### SUMMARY

The present disclosure has been made in view of the above problems, and it is an object of the present disclosure to provide a technology for, during mating between connectors, bending a plurality of parts of a terminal by pressing of a terminal and a partition wall of a mating connector, thereby forming multiple contact points.

In particular, when applying a bent contact point to a terminal of a connector in order to implement multiple contact points, a lead portion of the terminal is greatly bent by an amount equivalent to the curvature height of the bent point during mating between connectors, which causes severe stress to be applied to a core portion of the terminal supported by a housing. It is another object of the present disclosure to solve the problem of deformation of the terminal or breakage of the core portion supporting the terminal.

In addition, when mating and disconnection between the connectors are repeatedly performed, stress due to pressing between the bent contact points of the terminal is continuously accumulated in the terminal, and therefore the bent contact point of the terminal is deformed, whereby the curvature thereof is reduced. This leads to a non-contact problem where the contact point of the connector fails to make contact with the terminal of the mating connector. It is another object of the present disclosure to solve the above problem.

Furthermore, conventional connectors require separate structural designs and individually manufactured components for each type: a plug connector, a receptacle connector, or a hermaphroditic connector. Since the structure and components differ by connector type, therefore, manufacturing costs increase and there is a problem of lack of compatibility between parts. It is a further object of the present disclosure to solve the above problem.

The objects of the present disclosure are not limited to the aforementioned objects, and other unmentioned objects and advantages will be clearly understood by a person having ordinary skill in the art to which the present disclosure pertains based on the following description.

In accordance with an aspect of the present disclosure, the above and other objects can be accomplished by the provision of a connector including a contact unit including a lead portion configured such that a part of the lead portion forming a contact point with a mating terminal extends straight without bending and a head portion bent from the lead portion toward a partition wall, the head portion extending straight, and a partition wall provided so as to correspond to the contact unit, the partition wall being configured to provide a space configured to support the contact unit, wherein a connection region between the head portion and the lead portion is bent in one direction by pressing of the mating terminal and pressing of the partition wall due to mating with a mating connector, thereby forming a first contact point in contact with the mating terminal, and a part of the lead portion is bent in the other direction, thereby forming a second contact point in contact with the mating terminal.

In an example, the connector may include a lead frame assembly including a terminal including the contact unit configured to form a contact point with the mating terminal, a mounting portion mounted to a substrate, and a signal transmission line portion configured to connect the contact unit and the mounting portion to each other, and a frame body in which signal transmission line portions of a plurality of terminals are arranged and assembled or molded, the frame body being configured to support a plurality of contact units, the plurality of contact units being arranged in the one direction to form a contact array.

In an example, the lead frame assembly may include an A-type lead frame assembly configured such that the header portion is bent relative to the lead portion in a first direction and a B-type lead frame assembly configured such that the header portion is bent relative to the lead portion in a second direction opposite the first direction, and the A-type lead frame assembly and the B-type lead frame assembly may be alternately disposed.

In an example, the type of the connector may be determined as any one of a plug connector, a receptacle connector, and a hermaphroditic connector based on the combination and arrangement sequence of the A-type lead frame assembly and the B-type lead frame assembly.

In an example, the A-type lead frame assembly and the B-type lead frame assembly of the lead frame assembly may be alternately arranged in plural, and the connector may include a header housing in which the partition wall is provided so as to correspond to the combination and arrangement sequence of the plurality of lead frame assemblies and into which a part of a front end of each of the plurality of lead frame assemblies is inserted and mounted.

In accordance with another aspect of the present disclosure, there is provided a connector system including a first connector including a first contact unit including a first lead portion configured such that a part of the first lead portion forming a contact point with a mating terminal extends straight without bending and a first head portion bent from the first lead portion toward a first partition wall, the first head portion extending straight, and a first partition wall provided so as to correspond to the first contact unit, the first partition wall being configured to provide a space configured to support the first contact unit, and a second connector including a second contact unit in contact with the first contact unit, the second contact unit being configured to form a contact point, wherein, upon mating between the first connector and the second connector, the first contact unit is bent by pressing of the second contact unit and pressing of first partition wall, thereby forming dual contact points with the second contact unit.

In an example, the second contact unit may include a second lead portion configured such that a part of the second lead portion forming a contact point with the first contact unit extends straight without bending and a second head portion bent from the second lead portion toward a second partition wall, the second head portion extending straight, and the first contact unit and the second contact unit may be mirror images of each other symmetrical about a mating axis.

In an example, in an initial mating state between the first connector and the second connector, the second lead portion of the second contact unit may be located in a space formed by extending the distance between an upper end surface of the first lead portion and the first partition wall.

In an example, a connection region between the first lead portion and the first head portion may contact and press the second lead portion to form a first contact point, and a connection region between the second lead portion and the second head portion may contact and press the first lead portion to form a second contact point.

In an example, pressing force at which a connection region between the first lead portion and the first head portion contacts and presses the second lead portion and pressing force at which a connection region between the second lead portion and the second head portion contacts and presses the first lead portion may act as mating force between the first connector and the second connector.

In accordance with another aspect of the present disclosure, there is provided a connector including a lead frame assembly including a contact array in which a plurality of contact units, each including a lead portion and a head portion bent and extending from the lead portion, is arranged in one direction, wherein the lead frame assembly is divided into an A-type lead frame assembly configured such that the header portion is bent relative to the lead portion in a first direction and a B-type lead frame assembly configured such that the header portion is bent relative to the lead portion in a second direction opposite the first direction, and the A-type lead frame assembly and the B-type lead frame assembly are alternately disposed.

In accordance with a further aspect of the present disclosure, there is provided a connector mating method including an initial contact unit contact step of a first head portion of a first contact unit of a first connector and a second head portion of a second contact unit of a second connector coming into contact with each other to press each other, a top dead center arrival step of a first connection region between a first lead portion and the first head portion of the first contact unit and a second connection region between a second lead portion and the second head portion of the second contact unit contacting and pressing each other, whereby the first contact unit and the second contact unit reach the top dead center of bending deformation, and a dual contact point formation step of the first connection region of the first contact unit contacting and pressing the second lead portion of the second contact unit due to a first partition wall pressing the first head portion of the first contact unit to form a first contact point and the second connection region of the second contact unit contacting and pressing the first lead portion of the first contact unit due to a second partition wall pressing the second head portion of the second contact unit to form a second contact point.

In an example, the connector mating method may further include an initial connector mating step of the second lead portion of the second contact unit being located in a space formed by extending the distance between an upper end surface of the first lead portion of the first contact unit and the first partition wall and the first lead portion of the first contact unit being located in a space formed by extending the distance between an upper end surface of the second lead portion of the second contact unit and the second partition wall.

In an example, in the initial contact unit contact step, the first head portion of the first contact unit and the second head portion of the second contact unit may slide along inclined surfaces of each other due to pressing between the first head portion and the second head portion, whereby the first lead portion of the first contact unit and the second lead portion of the second contact unit may be bent in a curved shape in directions toward the first partition wall and the second partition wall, respectively, and the first head portion of the first contact unit and the second head portion of the second contact unit may contact and press each other due to the first partition wall and the second partition wall.

In an example, the connector mating method may further include a mating continuation step of, as the first connection region of the first contact unit and the second connection region of the second contact unit pass each other and move toward the second lead portion and the first lead portion, respectively, the first connection region of the first contact unit and the second connection region of the second contact unit protruding and moving toward the second lead portion and the first lead portion, respectively, due to pressing of the first partition wall and the second partition wall, thereby contacting and pressing the second lead portion and the first lead portion, respectively.

### BRIEF DESCRIPTION OF THE DRAWINGS

The accompanying drawings, which are incorporated in this specification, show exemplary embodiments and serve to further show the technical ideas of the present disclosure in conjunction with the detailed description of exemplary embodiments that follows, and the present disclosure is not to be construed as limited to what is shown in such drawings. In the drawings:

FIG. 1 shows a conventional dual contact point structure;

FIGS. 2A to 2C show a conventional connector mating process;

FIGS. 3A and 3B show an example of a plug connector applied as a first connector according to the present disclosure;

FIGS. 4A and 4B show an example of a receptacle connector applied as a second connector according to the present disclosure;

FIGS. 5A and 5B show an example of a hermaphroditic connector applied as the first connector and the second connector according to the present disclosure;

FIG. 6 is a sectional view of an embodiment of a lead frame assembly of a connector according to the present disclosure;

FIGS. 7A and 7B show an embodiment of the types of the lead frame assembly according to the present disclosure;

FIGS. 8A and 8B, 9A and 9B, and 10A and 10B show an embodiment of the combination and arrangement relationship of the lead frame assemblies constituting the connector according to the present disclosure;

FIG. 11 shows an example of the fastening relationship between the lead frame assembly and a retainer in the connector according to the present disclosure;

FIGS. 12A and 12B show an example of a plug header housing in the connector according to the present disclosure;

FIGS. 13A and 13B show an example of a plug connector in which the lead frame assembly is mounted to the plug header housing in accordance with the present disclosure;

FIGS. 14A and 14B show an example of a receptacle header housing in the connector according to the present disclosure;

FIGS. 15A and 15B show an example of a receptacle connector in which the lead frame assembly is mounted to the receptacle header housing in accordance with the present disclosure;

FIGS. 16A and 16B show an example of a hermaphroditic header housing in the connector according to the present disclosure;

FIGS. 17A and 17B show an example of a hermaphroditic connector in which the lead frame assembly is mounted to the hermaphroditic header housing in accordance with the present disclosure;

FIGS. 18A and 18B show an example of a connector system according to the present disclosure;

FIG. 19 shows an example of the mating relationship between connectors in the connector system according to the present disclosure;

FIGS. 20A and 20B show another example of the connector system according to the present disclosure;

FIG. 21 shows an embodiment of a multiple contact point structure of the connector according to the present disclosure; and

FIGS. 22 to 26 show an embodiment of processes of a connector mating method according to the present disclosure.

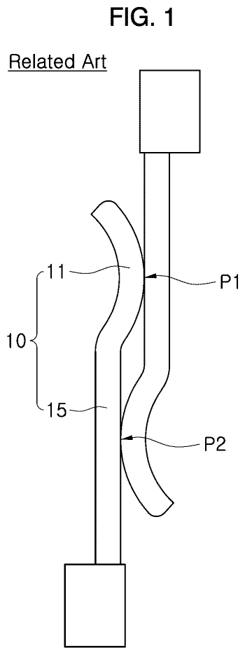

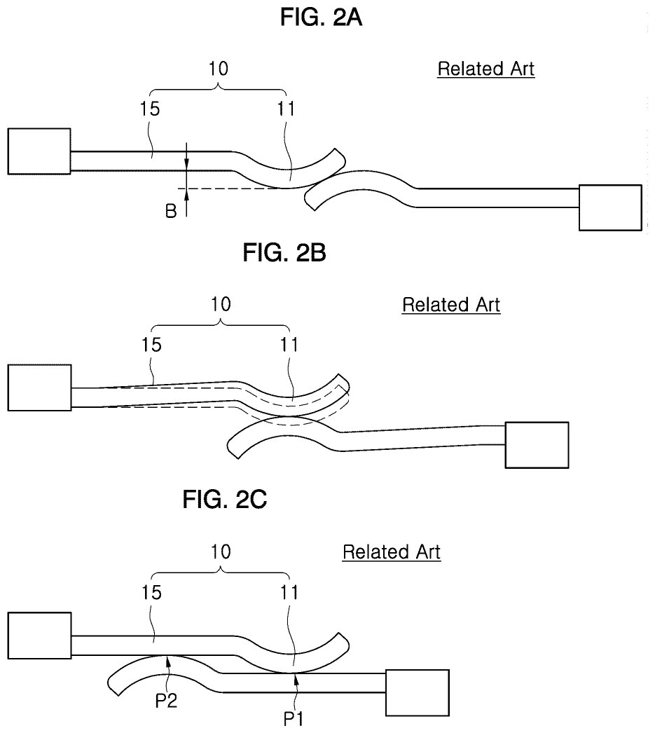

### DETAILED DESCRIPTION OF EXEMPLARY EMBODIMENTS

In order to describe the present disclosure, operational advantages of the present disclosure, and objects achieved by practicing the present disclosure, preferred embodiments of the present disclosure will hereinafter be illustrated and a description will be given with reference thereto.

First, it should be noted that the terminology used in the present application is used only to describe specific embodiments and is not intended to limit the present disclosure, and singular forms are intended to include plurality of forms unless mentioned otherwise. It should also be understood that in the present application, the terms “including” or “having” and the like are intended to designate the presence of the features, numbers, steps, operations, components, parts, or combinations thereof described in the specification, and not to preclude the possibility of the presence or addition of one or more other features, numbers, steps, operations, components, parts, or combinations thereof.

In describing the present disclosure, a detailed description of known configurations or functions incorporated herein will be omitted when the same may obscure the subject matter of the present disclosure.

The present disclosure proposes a technology wherein, during mating between connectors, pressure applied by terminals and partition walls of the mating connectors causes a plurality of parts of the terminals to be bent and deformed, thereby forming multiple contact points. Furthermore, the present disclosure provides a technology for selectively determining the type of the connector through the combination and arrangement relationship of a lead frame assembly.

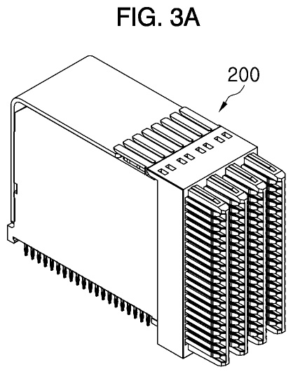

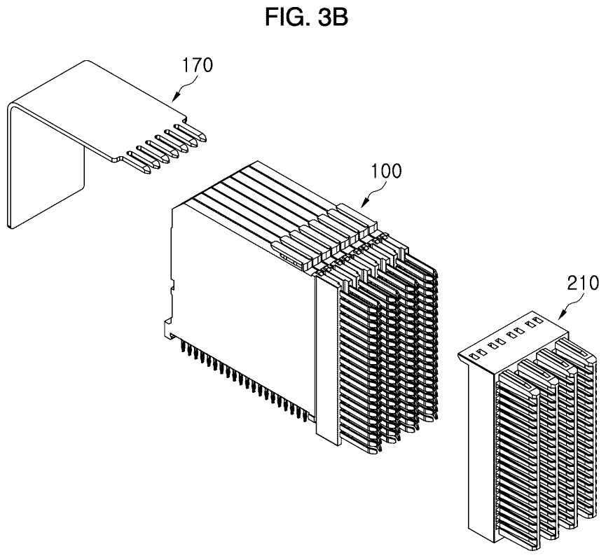

FIGS. 3 to 5 show an embodiment of a connector according to the present disclosure.

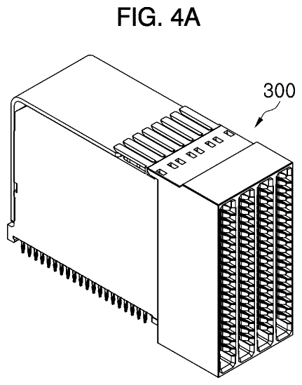

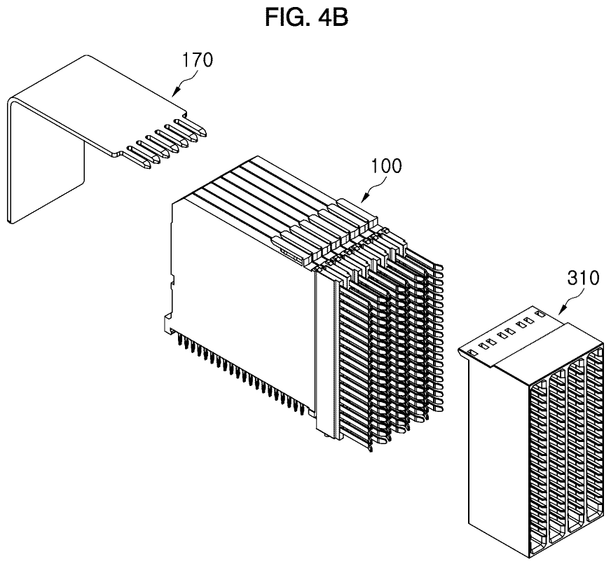

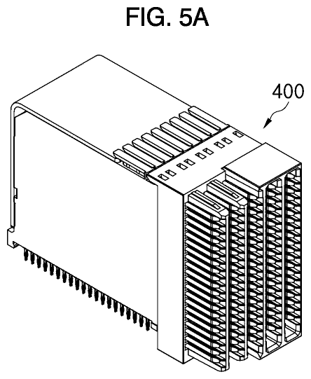

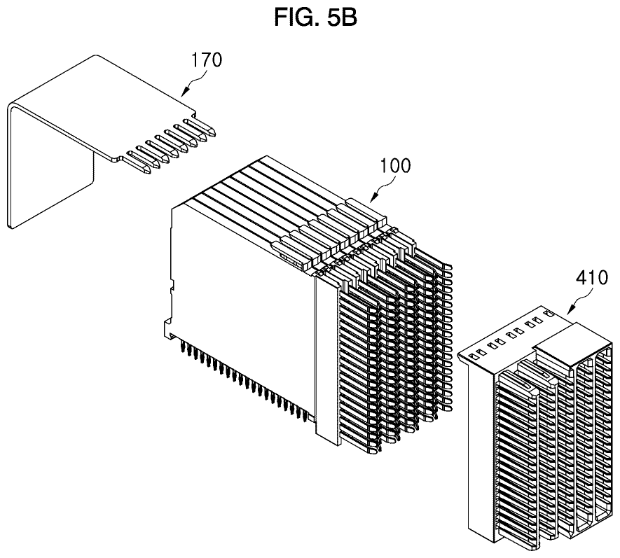

FIG. 3 shows an example of a plug connector 200 applied as a first connector according to the present disclosure, FIG. 4 shows an example of a receptacle connector 300 applied as a second connector according to the present disclosure, and FIG. 5 shows an example of a hermaphroditic connector 400 applied as the first connector and the second connector according to the present disclosure.

The plug connector 200, the receptacle connector 300, or the hermaphroditic connector 400 may include a plurality of lead frame assemblies 100, a header housing 210, 310, or 410, and a retainer 170.

The plug connector 200, the receptacle connector 300, or the hermaphroditic connector 400 may be configured by the header housing 210, 310, or 410 being coupled to the front of the plurality of lead frame assemblies 100 and the retainer 170 being coupled to the rear of the plurality of lead frame assemblies 100 in the state in which the plurality of lead frame assemblies 100 is sequentially arranged.

In the present disclosure, the type of the connector may be determined based on the combination and arrangement relationship of the lead frame assemblies 100 and the optional mounting of the header housing 210, 310, or 410. This will be described hereinafter with reference to embodiments.

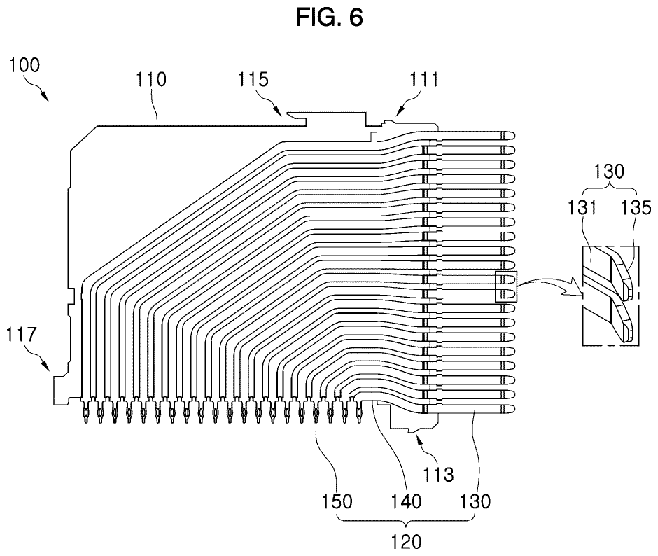

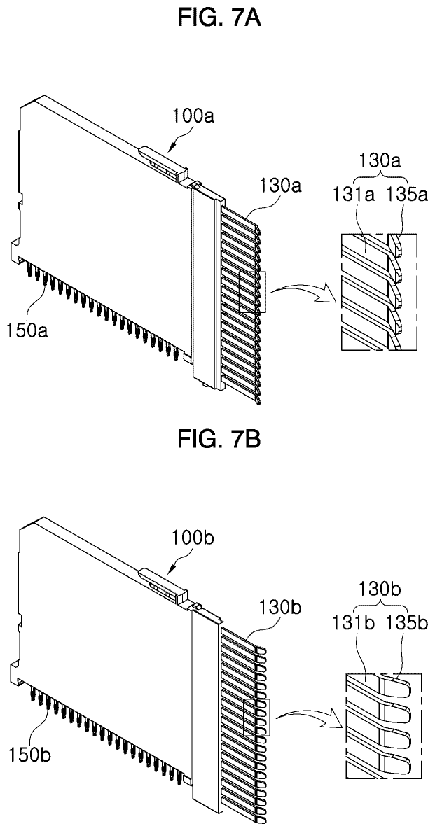

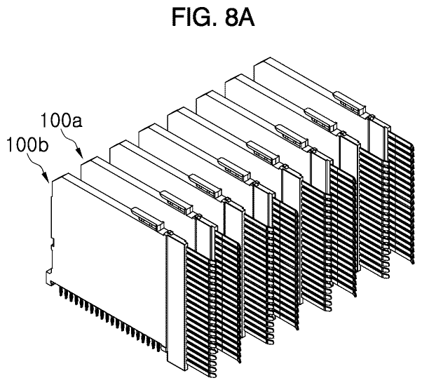

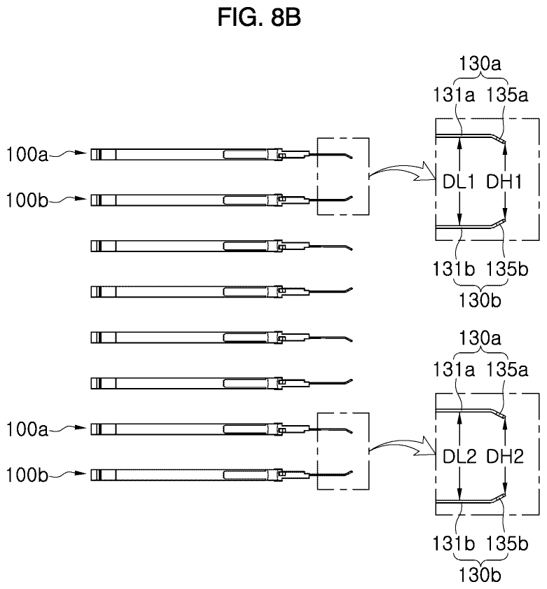

FIG. 6 is a sectional view of an embodiment of the lead frame assembly of a connector according to the present disclosure, FIG. 7 shows an embodiment of the types of the lead frame assembly according to the present disclosure, and FIGS. 8 to 10 show an embodiment of the combination and arrangement relationship of the lead frame assemblies constituting the connector according to the present disclosure.

The lead frame assembly 100 may include a plurality of terminals 120 and a frame body 110.

Each terminal 120 may include a contact unit 130, a signal transmission line portion 140, and a mounting portion 150.

A plurality of terminals 120 is arranged in the lead frame assembly 100. The contact unit 130 of the terminal 120 may be exposed in a direction toward one side surface of the frame body 110, and the mounting portion 150 of the terminal 120 may be exposed downwardly of the frame body 110.

The plurality of contact units 130 may be arranged from an upper side to a lower side of one side surface of the frame body 110, forming a contact array. The contact units 130 may form signal transmission contacts by at least partially contacting the contact units of a mating connector during connector mating.

More specifically, the contact unit 130 may include a lead portion 131 and a head portion 135. The head portion 135 may also be referred to as a header portion.

One end of the lead portion 131 may be connected to the signal transmission line portion 140 and may be supported by the frame body 110. The lead portion 131 may extend straight without bending while being supported by the frame body 110.

In an example, the lead portion 131 may extend straight without bending throughout the entire length thereof from a core portion supported by the frame body 110 to the head portion 135. In another example, the lead portion 131 may have a shape, such as a bent shape, near the core portion supported by the frame body 110 for more stable support, and may extend straight without bending in the contact point forming portion that contacts the contact unit of the mating connector.

The other end of the lead portion 131 may be connected to the head portion 135.

The head portion 135 may be bent relative to the lead portion 131. Preferably, the head portion 135 may be bent at a predetermined angle from the lead portion 131 in a diagonal direction and extend straight.

The bending angle of the head portion 135 may be appropriately adjusted based on the length of the head portion 135, the distance from the partition wall, and the height relationship with the lead portion of the mating connector, which will be described later.

The head portion 135 may be bent relative to the lead portion 131 in a first direction or in a second direction opposite the first direction.

Depending on the bending direction of the lead portion 131, the lead frame assembly 100 may be classified as an A-type lead frame assembly 100a or a B-type lead frame assembly 100b.

When the head portion 135 is bent relative to the lead portion 131 in the first direction, the lead frame assembly may be an A-type lead frame assembly 100a. When the head portion 135 is bent relative to the lead portion 131 in the second direction, the lead frame assembly 100 may be a B-type lead frame assembly 100b.

FIG. 7A shows an A-type lead frame assembly 100a, and FIG. 7B shows a B-type lead frame assembly 100b.

The A-type lead frame assembly 100a is configured such that the head portion 135a of the contact unit 130a is bent relative to the lead portion 131a in the first direction, and the B-type lead frame assembly 100b is configured such that the head portion 135b of the contact unit 130b is bent relative to the lead portion 131b in the second direction opposite to the first direction.

In an example, the contact unit 130a of the A-type lead frame assembly 100a and the contact unit 130b of the B-type lead frame assembly 100b may be formed as symmetrical mirror images.

In an example, in order to increase mounting density on the substrate while saving space, the mounting portion 150a of the A-type lead frame assembly 100a and the mounting portion 150b of the B-type lead frame assembly 100b may be formed with the positions thereof offset relative to each other.

In the present disclosure, the type of the connector may be determined as the plug connector 200, the receptacle connector 300, or the hermaphroditic connector 400 based on the combination and arrangement sequence of the A-type lead frame assembly 100a and the B-type lead frame assembly 100b.

For example, as shown in FIG. 8, when the A-type lead frame assembly 100a and the B-type lead frame assembly 100b are arranged in a consecutive combination, wherein the A-type lead frame assembly 100a and the B-type lead frame assembly 100b are alternately disposed such that the distance between the ends of the head portions 135a and 135b of the contact units 130a and 130b decreases by disposing the last two consecutively adjacent lead frame assemblies 100a and 100b on the left and right sides such that the bending directions of the head portions 135a and 135b face each other, the plug connector 200 as shown in FIG. 3 may be configured.

In an example, when the A-type lead frame assembly 100a and the B-type lead frame assembly 100b are alternately disposed such that the distances DH1 and DH2 between the head portions 135a and 135b of the two last consecutively arranged lead frame assemblies 100a and 100b on the left and right sides are less than the distances DL1 and DL2 between the lead portions 131a and 131b of the two last consecutively arranged lead frame assemblies 100a and 100b, the plug connector 200 may be configured.

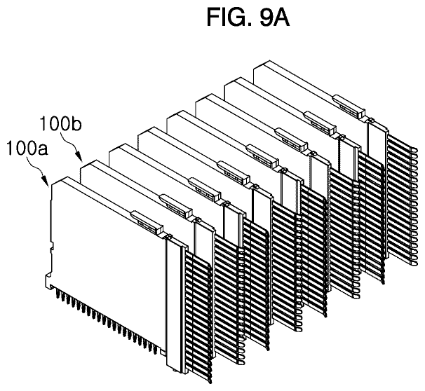

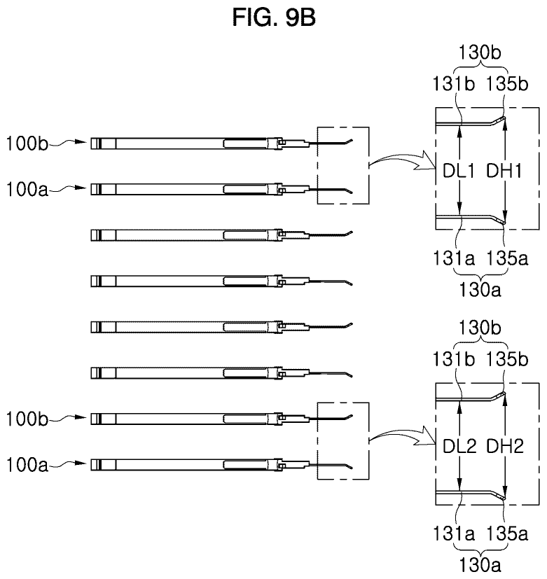

Alternatively, as shown in FIG. 9, when the A-type lead frame assembly 100a and the B-type lead frame assembly 100b are arranged in a consecutive combination, wherein the A-type lead frame assembly 100a and the B-type lead frame assembly 100b are alternately disposed such that the distance between the ends of the head portions 135a and 135b of the contact units 130a and 130b increases by disposing the last two consecutively adjacent lead frame assemblies 100a and 100b on the left and right sides such that the bending directions of the contact units 130a and 130b are opposite each other, the receptacle connector 300 as shown in FIG. 4 may be configured.

In an example, when the A-type lead frame assembly 100a and the B-type lead frame assembly 100b are alternately disposed such that the distances DH1 and DH2 between the ends of the head portions 135a and 135b of the two last consecutively arranged lead frame assemblies 100a and 100b on the left and right sides are greater than the distances DL1 and DL2 between the lead portions 131a and 131b of the two last consecutively arranged lead frame assemblies 100a and 100b, the receptacle connector 300 may be configured.

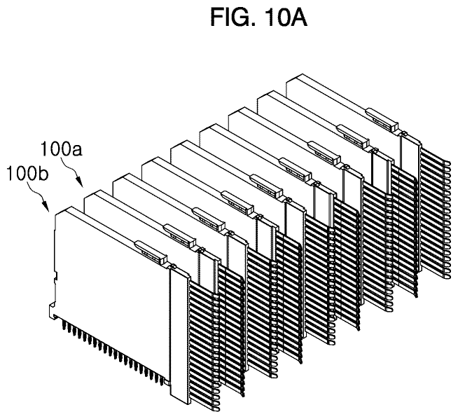

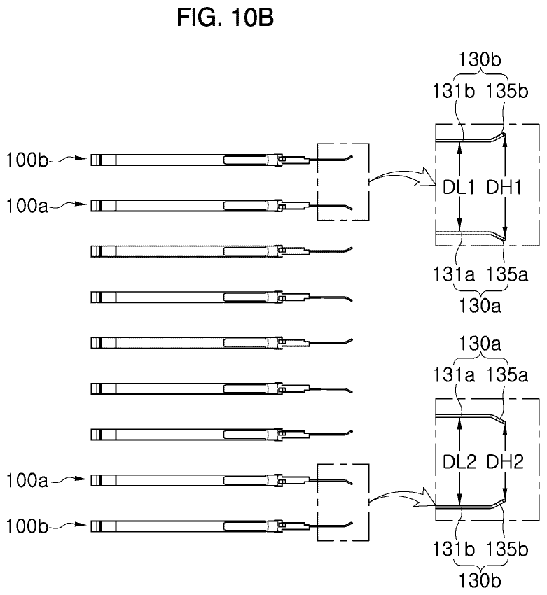

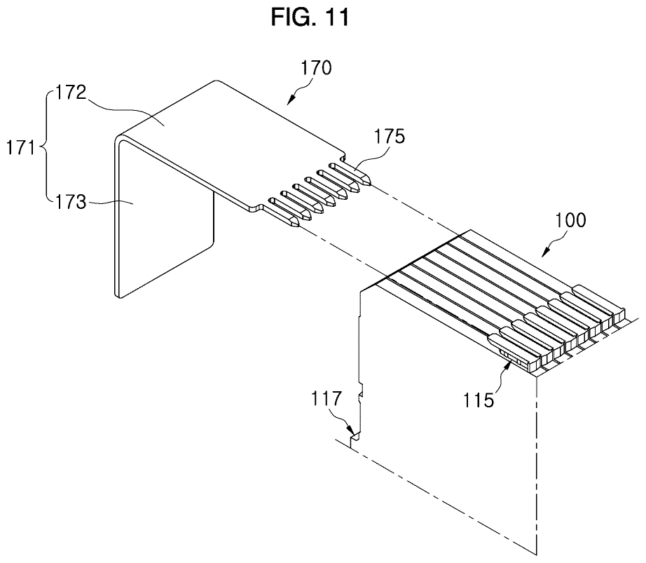

In addition, as shown in FIG. 10, when the A-type lead frame assembly 100a and the B-type lead frame assembly 100b are arranged in a consecutive combination, wherein the A-type lead frame assembly 100a and the B-type lead frame assembly 100b are alternately disposed such that the distance between the ends of the head portions 135a and 135b of the contact units 130a and 130b decreases by disposing the last two consecutively adjacent lead frame assemblies 100a and 100b on one of the left and right sides such that the bending directions of the contact units 130a and 130b face each other and the distance between the ends of the head portions 135a and 135b of the contact units 130a and 130b increases by disposing the last two consecutively adjacent lead frame assemblies 100a and 100b on the other of the left and right sides such that the bending directions of the contact units 130a and 130b are opposite each other, the hermaphroditic connector 400 as shown in FIG. 5 may be configured.

In an example, when the A-type lead frame assembly 100a and the B-type lead frame assembly 100b are alternately disposed such that the distance DH1 between the ends of the head portions 135a and 135b of the two last consecutively arranged lead frame assemblies 100a and 100b on the right side is greater than the distance DL1 between the lead portions 131a and 131b of the two last consecutively arranged lead frame assemblies 100a and 100b and the distance DH2 between the ends of the head portions 135a and 135b of the two last consecutively arranged lead frame assemblies 100a and 100b on the left side is less than the distance DL2 between the lead portions 131a and 131b of the two last consecutively arranged lead frame assemblies 100a and 100b, the hermaphroditic connector 400 may be configured.

As such, in the present disclosure, the type of the connector may be determined as the plug connector 200, the receptacle connector 300, or the hermaphroditic connector 400 by selectively adjusting the combination and arrangement relationship of the lead frame assemblies 100.

The A-type lead frame assembly 100a and the B-type lead frame assembly 100b are similar to each other except that the bending directions of the ends of the contact units 130a and 130b are different from each other, and therefore the A-type lead frame assembly 100a and the B-type lead frame assembly 100b will hereinafter be collectively referred to as the lead frame assembly 100.

The lead frame assembly 100 will hereinafter be described with reference back to FIG. 6.

A plurality of mounting portions 150 may be arranged downwardly of the frame body 110. The mounting portion 150 may be mounted to a substrate. The mounting portion 150 may be inserted into and mounted to a mounting hole provided in the substrate by press fitting. In addition, the mounting portion 150 may be mounted to the substrate using various methods such as ball grid or soldering.

The signal transmission line portion 140 may electrically connect the contact unit 130 and the mounting portion 150 to each other.

In an example, the frame body 110 may be formed so as to envelop the signal transmission line portion 140 by molding. Alternatively, recesses, into which the signal transmission line portions 140 are inserted and mounted, may be formed in the frame body 110, whereby the terminals 120 may be mounted to the frame body 110 for assembly.

A fastening recess 115, into which a fastening bar of the retainer 170 can be inserted and fastened, may be provided in an upper end surface of the frame body 110. A seating surface 117, onto which the retainer 170 is seated, may be provided on a rear surface of the frame body 110.

Fastening protrusions 111 and 113, which are coupled to fastening holes of the header housing 210, 310, or 410, may be provided on one side of the upper end surface and one side of a lower end surface of the frame body 110.

FIG. 11 shows an example of the fastening relationship between the lead frame assembly and the retainer in the connector according to the present disclosure.

The retainer 170 may include a retainer upper plate 172 and a retainer rear plate 173 such that a retainer body 171 is in tight contact with the upper end surface and the rear surface of the frame body 110. In an example, the retainer upper plate 172 and the retainer rear plate 173 may be formed by bending a single plate.

A fastening bar 175 may be provided at the end of the retainer upper plate 172. In an example, a plurality of fastening bars 175 may be provided, and the number of fastening bars 175 may be adjusted so as to correspond to the number of lead frame assemblies 100 that are disposed.

Each fastening bar 175 may be inserted into and fastened to the fastening recesses 115 of two consecutively disposed lead frame assemblies 100. That is, a single fastening bar 175 may be inserted into and fastened to the fastening recesses 115 of two lead frame assemblies 100, whereby the arrangement state of the two consecutively disposed lead frame assemblies 100 may be maintained, and the plurality of fastening bars 175 is inserted into and fastened to the fastening recesses 115 of the plurality of lead frame assemblies 100, whereby the overall arrangement configuration of the plurality of combined and arranged lead frame assemblies 100 may be maintained.

The number, shape, and form of the fastening bars 175 may be varied. For example, a single fastening bar may be inserted into and fastened to the fastening recesses 115 of three or more lead frame assemblies 100, or a single fastening bar may be inserted into and fastened to the fastening recesses 115 of all of the plurality of lead frame assemblies 100.

The end of the retainer rear plate 173 may be seated on the seating surface 117 provided on the rear surface of the frame body 110. Preferably, the length of the retainer rear plate 173 may be formed so as to correspond to the length from an upper side of the rear surface of the frame body 110 to the seating surface 117 such that the end of the retainer rear plate 173 can be pressed onto the seating surface 117 of the frame body 110 in tight contact therewith to generate tension.

The end of the retainer rear plate 173 is pressed onto the seating surface 117 of the frame body 110 to generate tension in the state in which the fastening bar 175 of the retainer upper plate 172 is inserted into and fastened to the fastening recess 115 of the lead frame assembly 100, which allows the retainer 170 to more securely maintain the overall arrangement of the plurality of lead frame assemblies 100.

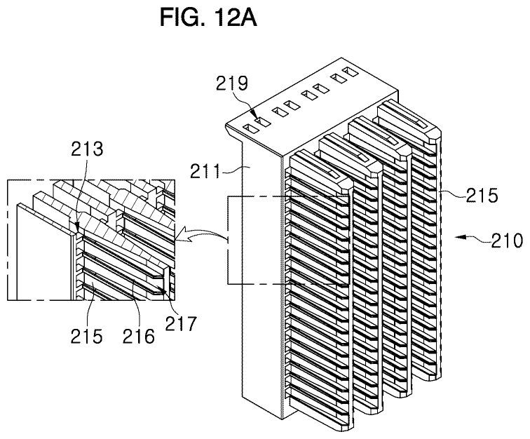

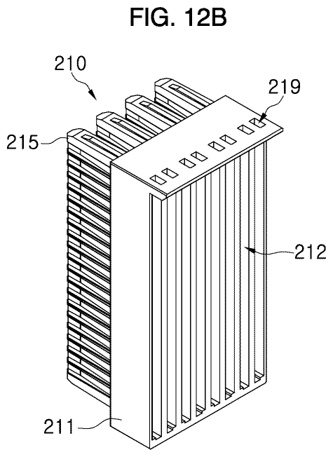

FIGS. 12 to 16 show an embodiment of a header housing in the connector according to the present disclosure and an embodiment of the mounting relationship between the header housing and the lead frame assembly.

The header housings 210, 310, and 410 may be divided into a plug header housing 210, a receptacle header housing 310, and a hermaphroditic header housing 410 based on the type of the connector.

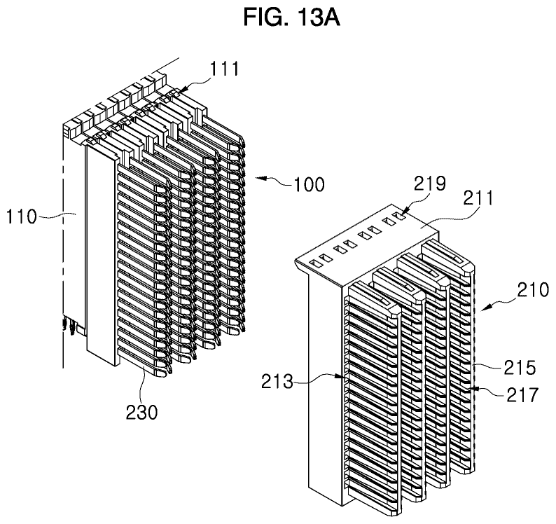

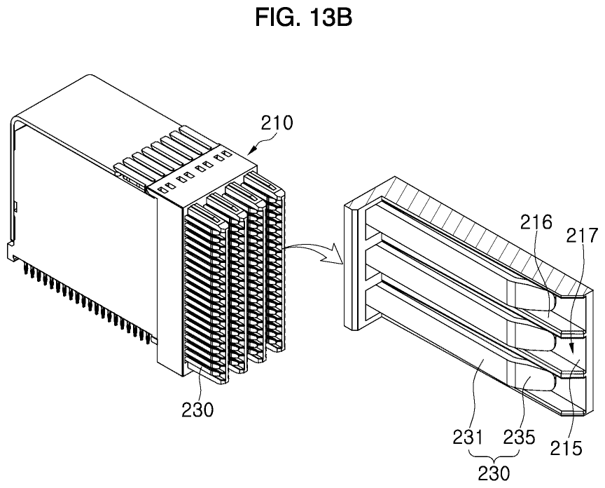

FIG. 12 shows an example of the plug header housing 210, and FIG. 13 shows a plug connector 200 in which the lead frame assembly 100 is mounted to the plug header housing 210.

A plurality of lead frame assemblies 100 combined and arranged so as to correspond to the plug connector as shown in FIG. 8 may be inserted into and mounted to the plug header housing 210.

The plug header housing 210 may include a plug header body 211, a plurality of partition walls 215, and a lead frame mounting slot 212.

The plug header body 211 may envelop a part of a front end of each of the plurality of lead frame assemblies 100 and may be fastened to the lead frame assemblies 100.

The lead frame mounting slot 212, into which a part of the front end of each of the plurality of arranged lead frame assemblies 100 is inserted and mounted, may be provided in a rear surface of the plug header body 211. A part of the front end of each lead frame assembly 100 may be inserted into and mounted to the lead frame mounting slot 212.

A contact unit mounting hole 213, through which the contact unit 230 of the lead frame assembly 100 extends and is exposed externally, may be provided in a front surface of the plug header body 211. When the lead frame assembly 100 is mounted to the lead frame mounting slot 212, the contact unit 230 of the lead frame assembly 100 may be exposed externally through the contact unit mounting hole 213.

The plurality of partition walls 215 may extend from the front surface of the plug header body 211. The partition walls 215 may be provided between the contact arrays of two lead frame assemblies 100 so as to correspond to the contact unit mounting hole 213. That is, a single partition wall 215 may be provided between the contact arrays of the two lead frame assemblies 100.

A plurality of ribs 216 may protrude from the partition walls 215. The contact unit 230 of the lead frame assembly 100 may be located between each pair of the plurality of ribs 216. The space formed by the partition wall 215 and the two ribs 216 may function as a contact unit support space 217.

When the plug header housing 210 is mounted to the front end of each of the plurality of lead frame assemblies 100, the contact unit 230 of the lead frame assembly 100 is located in each contact unit support space 217.

Locating the contact unit 230 of the lead frame assembly 100 in the contact unit support space 217 may prevent the contact unit 230 from being pushed rearward beyond a certain level through the partition wall 215 and prevent the contact unit 230 from deviating laterally through the rib 216.

More specifically, a lead portion 231 and a head portion 235 of the contact unit 230 are located on the contact unit support space 217. The head portion 235 is bent from the lead portion 231 in a direction toward the partition wall 215 and extends in a straight line.

In the state in which the connectors are not mated, the end of the head portion 235 may be spaced apart from the partition wall 215 by a certain distance. As the end of the head portion 235 is spaced apart from the partition wall 215, it is possible to more easily press the mating contact unit during mating with the mating connector. Alternatively, in the state in which the connectors are not mated, the end of the head portion 235 may be in contact with the partition wall 215.

Particularly, in the present disclosure, during mating between the connectors, contact pressure is applied to the end of the head portion 235 via the partition wall 215, causing bending deformation of the contact unit 230 to form a contact point with the contact unit of the mating connector. This will hereinafter be described in detail with reference to an embodiment.

In the present disclosure, as described above, the plurality of lead frame assemblies 100 are combined and disposed so as to correspond to the plug connector, and the plug header housing 210 is mounted to the front end of each of the plurality of lead frame assemblies 100, whereby the plug connector may be selectively configured.

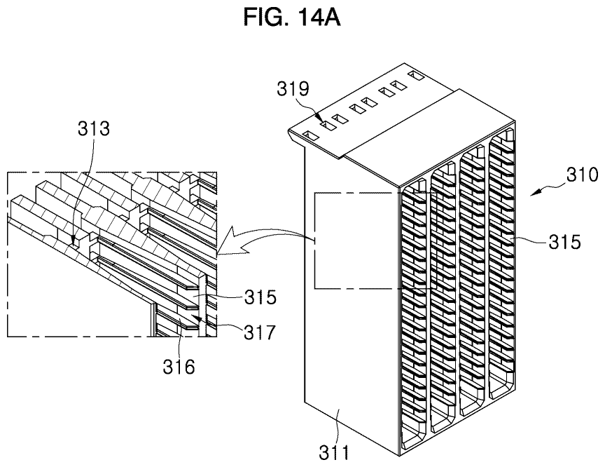

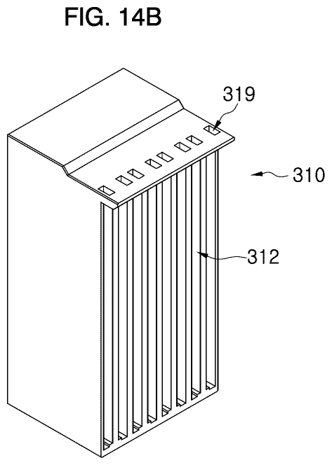

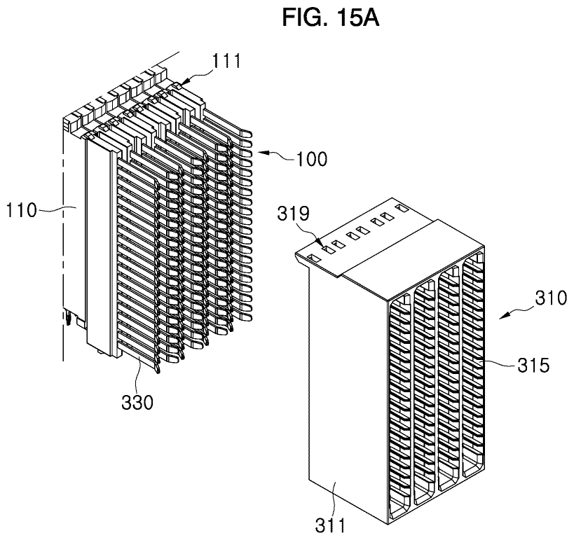

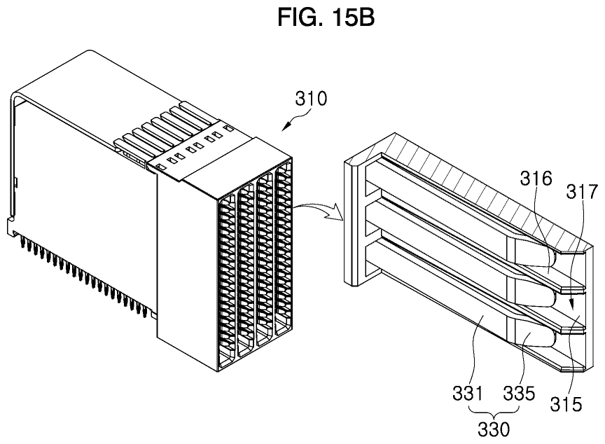

FIG. 14 shows an example of the receptacle header housing 310, and FIG. 15 shows the receptacle connector 300 in which the lead frame assembly 100 is mounted to the receptacle header housing 310.

A plurality of lead frame assemblies 100 combined and arranged so as to correspond to the receptacle connector as shown in FIG. 9 may be inserted into and mounted to the receptacle header housing 310.

The receptacle header housing 310 may include a plug header body 311, a plurality of partition walls 315, and a lead frame mounting slot 312.

In describing the receptacle header housing 310, descriptions of parts identical or similar to the previously described plug header housing 210 will be omitted or briefly given.

The receptacle header body 311 may envelop a front end of each of the plurality of lead frame assemblies 100 and may be fastened to the lead frame assemblies 100.

The lead frame mounting slot 312, into which a part of the front end of the lead frame assembly 100 is inserted and mounted, may be provided in a rear surface of the receptacle header body 311, and a contact unit mounting hole 313, through which a contact unit 330 of the lead frame assembly 100 extends and is exposed externally, may be provided in a front surface of the receptacle header body 311.

A front part of the receptacle header body 311 may extend such that the contact unit 330 of the lead frame assembly 100 is located therein. The plurality of partition walls 315 may be provided in an inner space of the front part of the receptacle header body 311. Upper and lower ends of the plurality of partition walls 315 may be connected to the receptacle header body 311. In addition, the left and right sides of the front part of the receptacle header body 311 may function as the partition walls 315.

A plurality of ribs 316 may protrude from the partition walls 315, and the space formed by the partition wall 215 and the two ribs 216 may function as a contact unit support space 317.

The arrangement of the contact unit support space 317 and the contact unit 330 is similar to that previously described for the plug header housing 210, and therefore a detailed description thereof will be omitted.

In the same manner as the plug connector, for the receptacle connector, during mating between the connectors, contact pressure is applied to the end of the head portion 335 of the contact unit 330 via the partition wall 315, causing bending deformation of the contact unit 330 to form a contact point with the contact unit of the mating connector.

In the present disclosure, as described above, the plurality of lead frame assemblies 100 is combined and disposed so as to correspond to the receptacle connector, and the receptacle header housing 310 is mounted to the front end of each of the plurality of lead frame assemblies 100, whereby the receptacle connector may be selectively configured.

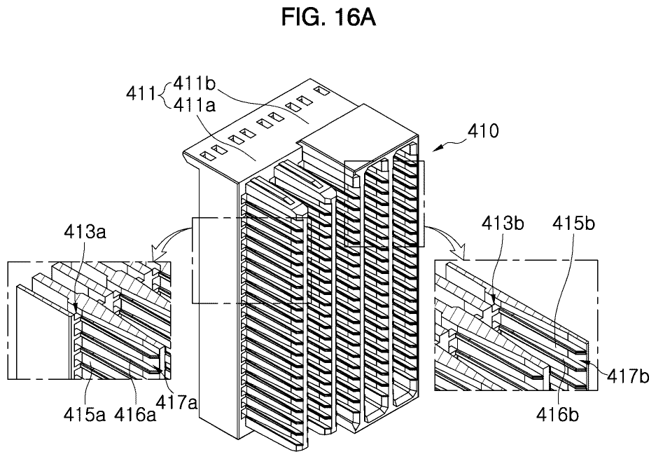

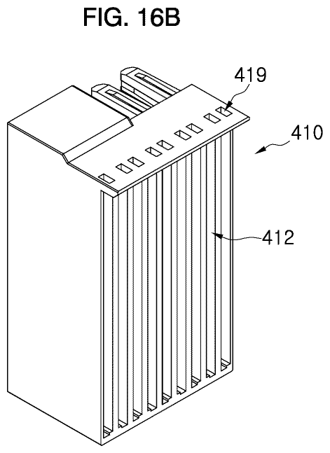

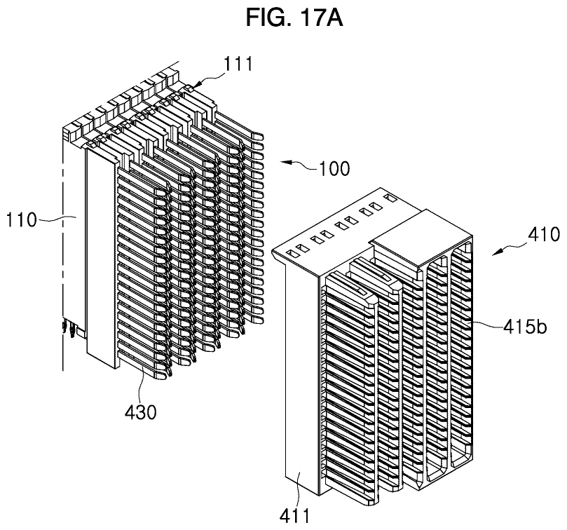

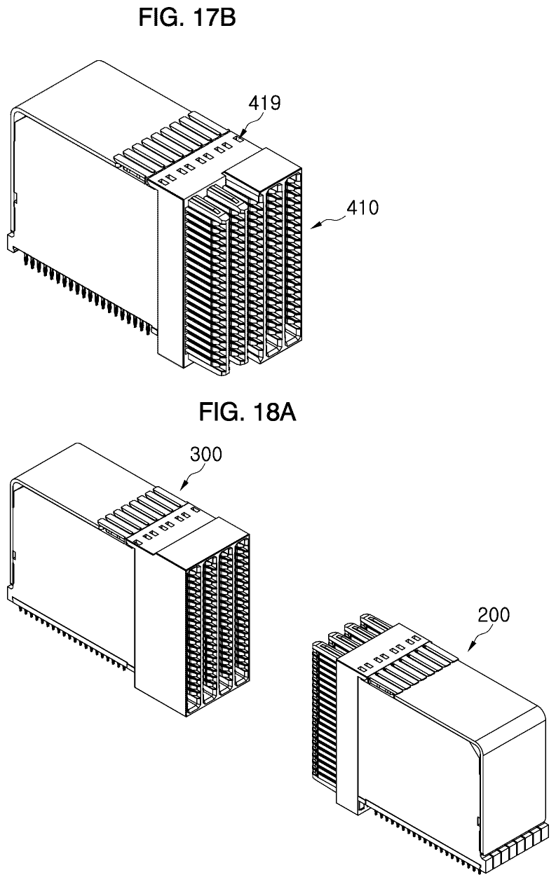

FIG. 16 shows an example of the hermaphroditic header housing 410, and FIG. 17 shows the hermaphroditic connector 400 in which the lead frame assembly 100 is mounted to the hermaphroditic header housing 410.

A plurality of lead frame assemblies 100 combined and arranged so as to correspond to the hermaphroditic connector as shown in FIG. 10 may be inserted into and mounted to the hermaphroditic header housing 410.

The hermaphroditic header housing 410 may include a hermaphroditic header body 411, a plurality of partition walls 415, and a lead frame mounting slot 412.

The lead frame mounting slot 412, into which a part of the front end of the lead frame assembly 100 is inserted and mounted, may be provided in a rear surface of the hermaphroditic header body 411, and contact unit mounting holes 413a and 423b, through which a contact unit 330 of the lead frame assembly 100 extends and is exposed externally, may be provided in a front surface of the hermaphroditic header body 411.

The hermaphroditic header body 411 of the hermaphroditic header housing 410 may include a plug region body 411a and a receptacle region body 411b.

In an example, the front end of the header body 411 may be divided into two regions, including a plug region body 411a where the header body does not extend forward and a receptacle region body 411b where the header body extends forward.

A plurality of partition walls 415a may extend from a front surface of the plug region body 411a, and a plurality of ribs 416a may protrude from the partition walls 415a. The partition walls 415a and the ribs 416a may form a contact unit support space 417a.

The receptacle region body 411b may extend forward such that a contact unit 430 of the lead frame assembly 100 is located therein. A plurality of partition walls 415b may be provided in an inner space of the receptacle region body 411b. A plurality of ribs 416b may protrude from the partition walls 415b, and a contact unit support space 417b may be formed by the partition walls 415b and the ribs 416b.

When the plurality of lead frame assemblies 100 is mounted to the hermaphroditic header body 411, the contact units 430 of the lead frame assemblies 100 are located in the respective contact unit support spaces 417a and 417b.

In this embodiment, the hermaphroditic header body 411 is divided into two regions: a plug region body 411a and a receptacle region body 411b. Alternatively, however, the hermaphroditic header body may be formed so as to be divided into a plurality of regions such that the plug region body and the receptacle region body are alternately disposed.

In the present disclosure, as described above, it is possible to selectively configure a hermaphroditic connector by combining and arranging a plurality of lead frame assemblies 100 so as to correspond to the hermaphroditic connector and mounting a hermaphroditic header housing 410 to the front end of each of the plurality of combined and arranged lead frame assemblies 100.

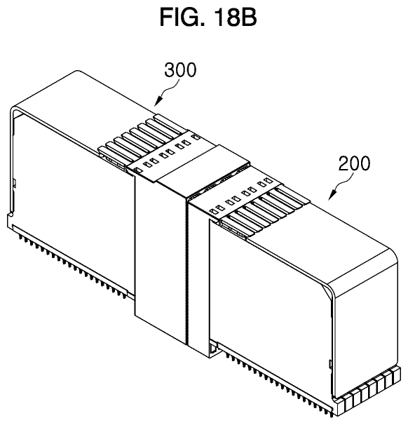

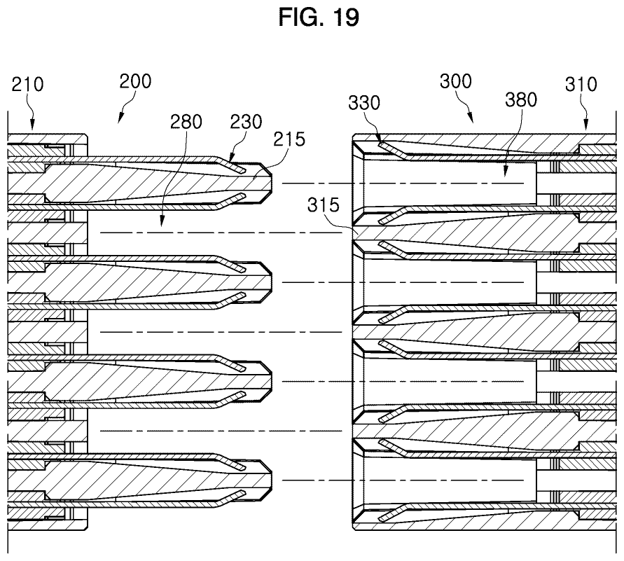

Furthermore, the present disclosure provides a connector system. FIG. 18 shows an example of a connector system according to the present disclosure, and FIG. 19 shows an example of the mating relationship between connectors in the connector system according to the present disclosure.

The connector system may include a first connector and a second connector.

As shown in FIG. 18 by way of example, the plug connector 200 described above may be applied as the first connector, and the receptacle connector 300 described above may be applied as the second connector. The plug connector 200 and the receptacle connector 300 may be mated with each other.

The plug header housing 210 of the previously described plug connector 200 and the receptacle header housing 310 of the receptacle connector 300 may correspond to each other so as to be fastened to each other. More specifically, the partition walls provided at the receptacle header housing 310 and the partition walls provided at the plug header housing 210 may be mated so as to intersect each other while corresponding to each other.

In an example, as shown in FIG. 19, the plug connector 200 as the first connector may have a first mating space 280 provided between the partition walls 215 where the contact units 230 are located. The first mating space 280 may correspond to the partition walls 315 of the receptacle connector 300 as the second connector where the contact units 330 are located.

In addition, the receptacle connector 300 as the second connector may have a second mating space 380 provided between the partition walls 315 where the contact units 330 are located. The second mating space 380 may correspond to the partition walls 215 of the plug connector 200 as the first connector where the contact units 230 are located.

The contact units 330 of the receptacle connector 300 are inserted into the first mating space 280 of the plug connector 200, and the contact units 230 of the plug connector 200 are inserted into the second mating space 380 of the receptacle connector 300, thereby establishing contact between the contact units 230 and 330 to form signal transmission contact points.

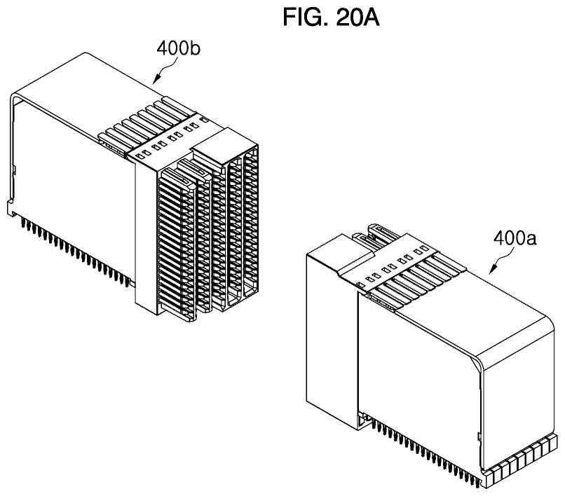

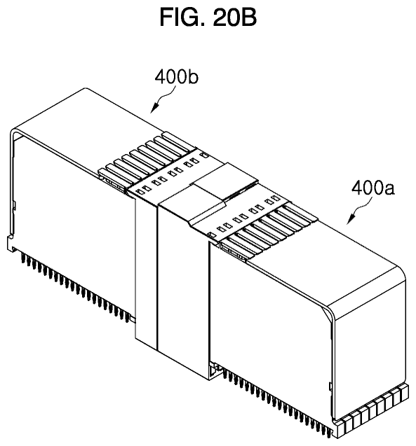

FIG. 20 shows another example of the connector system according to the present disclosure.

The hermaphroditic connectors 400a and 400b described above may be applied as a first connector and a second connector of the connector system.

The first connector and the second connector are identical hermaphroditic connectors 400a and 400b, wherein the second connector 400b may be rotated 180 degrees relative to the first connector 400a, whereby the first connector 400a and the second connector 400b may be mated.

In the present disclosure, as described above, the A-type lead frame assemblies and the B-type lead frame assemblies may be selectively combined and disposed so as to correspond to the plug connector, the receptacle connector, or the hermaphroditic connector, and the header housing may be selectively mounted so as to correspond to the type of the connector, whereby it is possible to easily selectively configure the plug connector, the receptacle connector, or the hermaphroditic connector according to the situation.

In addition, the present disclosure proposes a connector that forms multiple contact points upon mating between connectors, which will be described with reference to an embodiment.

Multiple contact point implementation technology according to the present disclosure may be applied to various connectors such as the plug connector, the receptacle connector, or the hermaphroditic connector according to the present disclosure described above.

Furthermore, although a connector configured such that the contact unit and the mounting portion are perpendicular to each other has been described as an embodiment of the connector according to the present disclosure described above, multiple contact point implementation technology according to the present disclosure is not limited thereto and may be applied to various connectors, such as a mezzanine-type connector or an edge-type connector.

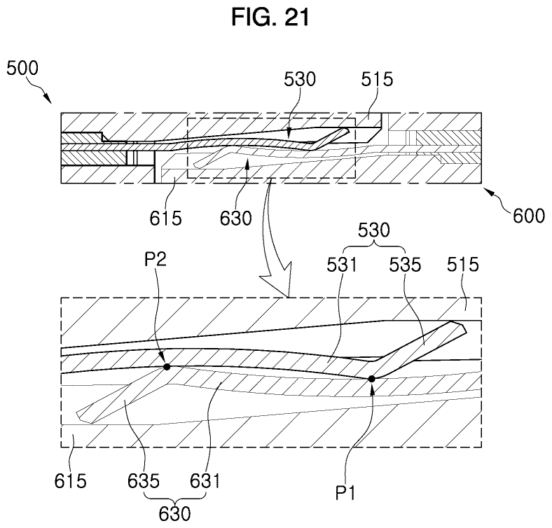

FIG. 21 shows an embodiment of a multiple contact point structure of the connector according to the present disclosure.

In the embodiment of FIG. 21, a first contact unit 530 and a second contact unit 630 of a first connector 500 are mirror images of each other symmetrical in form and shape about the mating axis. Since the multiple contact point structure is symmetrical, the multiple contact point structure will be described based on the first contact unit 530.

The first contact unit 530 of the first connector 500 may include a first lead portion 531 and a first head portion 535. The part of the first lead portion 531 that forms a contact point with the second contact unit 630 of the second connector 600 may extend straight without bending, and the first head portion 535 may be bent from the first lead portion 531 toward a first partition wall 515 and extend straight.

The first contact unit 530 of the first connector 500 may be bent by pressure applied by the second contact unit 630 and pressure applied by the first partition wall 515 upon mating with the second connector 600, thereby forming multiple contact points.

More specifically, when the first connector 500 and the second connector 600 are mated, the connection region between the first lead portion 531 and the first head portion 535 of the first contact unit 530 may come into contact with a second lead portion 631 of the second contact unit 630 due to the pressure applied by the first partition wall 515, thereby forming a first contact point.

Furthermore, in the state in which the first lead portion 531, which extends straight, of the first contact unit 530, is bent toward the first partition wall 515 due to the pressure applied by the second contact unit 630, the first lead portion 531 may come into contact with the connection region between the second lead portion 631 and a second head portion 635 of the second contact unit 630, thereby forming a second contact point.

In the above embodiment, the first contact unit 530 and the second contact unit 630 are mirror images of each other symmetrical in form and shape; however, the present disclosure is not limited thereto, and the first contact unit and the second contact unit may have different forms and shapes.

Although the first contact unit of the first connector includes a first lead portion, which extends straight without bending at the region where the contact point is formed, and a first head portion, which is bent from the first lead portion toward the first partition wall and extends straight, as described above, the second contact unit of the second connector may be configured such that at least one of the plurality of regions where the contact points is bent and protrudes in an arc shape.

That is, the present disclosure may be applied to the first contact unit of the first connector, whereas various forms contact units that form conventional plural contact points may be applied to the second contact unit of the second connector.

The present disclosure proposes a connector mating method adopting a multiple contact point structure. Hereinafter, a connector mating method according to the present disclosure will be described with reference to an embodiment.

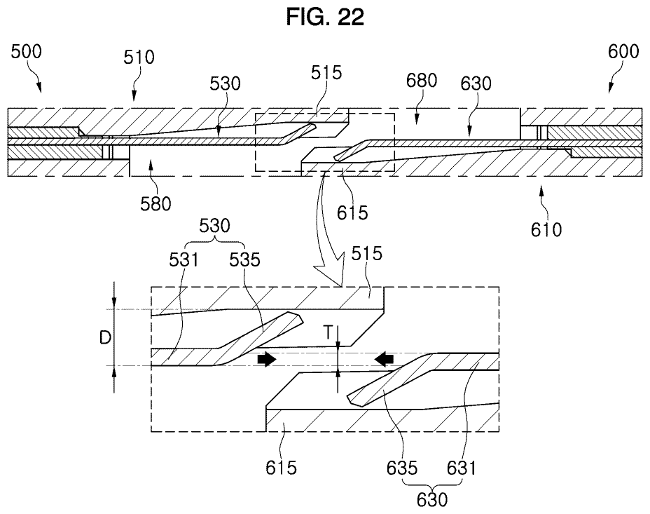

FIGS. 22 to 26 show an embodiment of processes of a connector mating method according to the present disclosure.

In this embodiment, the first contact unit 530 and the second contact unit 630 of the first connector 500 are mirror images of each other symmetrical in form and shape about the mating axis, and therefore the following description will be based on the first contact unit 530 of the first connector 500.

FIG. 22 shows an example of an initial mating state between the first connector 500 and the second connector 600.

In an initial state for mating, a first mating space 580 of the first connector 500 may correspond to a second partition wall 615 of the second connector 600 where the second contact unit 630 is located. In addition, a second mating space 680 of the second connector 600 may correspond to the first partition wall 515 of the first connector 500 where the first contact unit 530 is located.

When mating occurs between the first connector 500 and the second connector 600 in the initial state for mating, the first contact unit 530 and the second contact unit 630 may be automatically aligned in position by the housings and the partition walls of the first connector 500 and the second connector 600.

In the initial mating state, the first lead portion 531 of the first contact unit 530 may be spaced apart from the first partition wall 515 by a distance D. In addition, the second lead portion 631 may be located in a space formed by extending the distance D between the upper end surface of the first lead portion 531 and the first partition wall 515.

More specifically, in the initial mating state, the first contact unit 530 and the second contact unit 630 may be located so as to correspond to each other such that at least a part of the vertical sectional thickness of the first lead portion 531 and at least a part of the vertical sectional thickness of the second lead portion 631 overlap each other by a distance T.

In the state in which the first contact unit 530 of the first connector 500 and the second contact unit 630 of the second connector 600 are located as described above, mating between the first connector 500 and the second connector 600 may be performed.

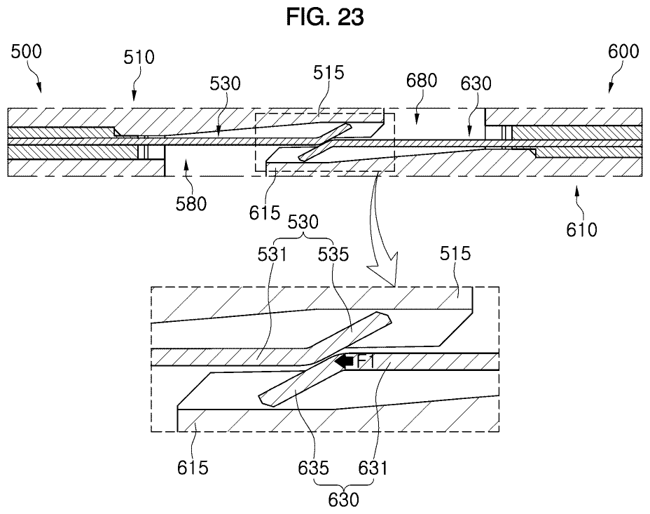

FIG. 23 shows an example of an initial contact state of the first contact unit 530 and the second contact unit 630 as the result of mating between the first connector 500 and the second connector 600.

The first head portion 535 of the first contact unit 530 and the second head portion 635 of the second contact unit 630 may be in contact with each other and press each other. For example, upon mating between the first connector 500 and the second connector 600, pressing force F1 by the second head portion 635 of the second contact unit 630 may be applied to the first head portion 535 of the first contact unit 530.

Since the first head portion 535 is bent relative to the first lead portion 531 at a predetermined angle toward the first partition wall 515, the second head portion 635 may slide along an inclined surface of the first head portion 535 under the pressing force F1, thereby pressing the first contact unit 530.

The first contact unit 530 is bent by pressing of the second contact unit 630. More specifically, the first lead portion 531 may be bent in a curved shape in a direction toward the first partition wall 515, and the first head portion 535 may be pushed toward the first partition wall 515 and come into contact with the first partition wall 515.

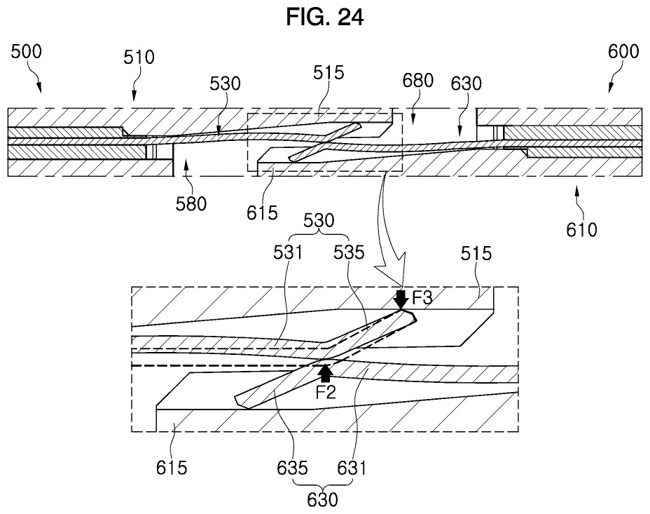

FIG. 24 shows an example of the top dead center of bending deformation of the first contact unit 530 and the second contact unit 630 as the result of mating between the first connector 500 and the second connector 600.

When the second contact unit 630 slides and reaches the top dead center, which is the point at which a first connection region between the first lead portion 531 and the first head portion 535 and a second connection region between the second lead portion 631 and the second head portion 635 meet each other, while pressing the first contact unit 530, the pressing force between the first contact unit 530 and the second contact unit 630 may reach the maximum value thereof.

At this time, the first lead portion 531 may exhibit the greatest curvature of a bending deformation curve compared to a normal state (a dotted line), and the first head portion 535 may be in contact with the first partition wall 515, whereby pressing force F3 may be generated by the first partition wall 515.

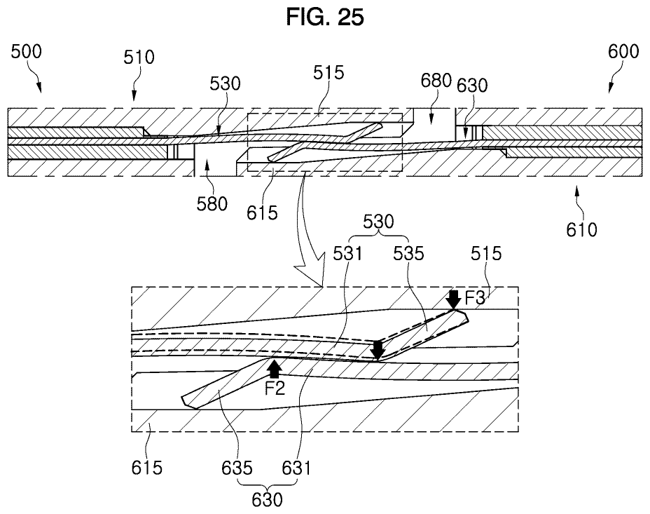

FIG. 25 shows an example of a mating continuation process after the top dead center of bending deformation of the first contact unit 530 and the second contact unit 630 as the result of mating between the first connector 500 and the second connector 600.

As the second contact unit 630 passes the top dead center and further advances into the first mating space 580 of the first connector 500, the pressing force between the first contact unit 530 and the second contact unit 630 gradually decreases from the maximum value thereof. Accordingly, the curvature of the bending deformation curve of the first lead portion 531 of the first contact unit 530 may become somewhat lower. At this time, since the second head portion 635 is being pressed by the second partition wall 615, the second connection region between the second lead portion 631 and the second head portion 635 may move toward the first lead portion 531, maintaining continuous contact and pressing the first lead portion 531.

In addition, since the pressing force F3 by the first partition wall 515 is applied to the first head portion 535 of the first contact unit 530, the first connection region between the first lead portion 531 and the first head portion 535 may move toward the second lead portion 631 of the second contact unit 630, thereby contacting and pressing the second lead portion 631.

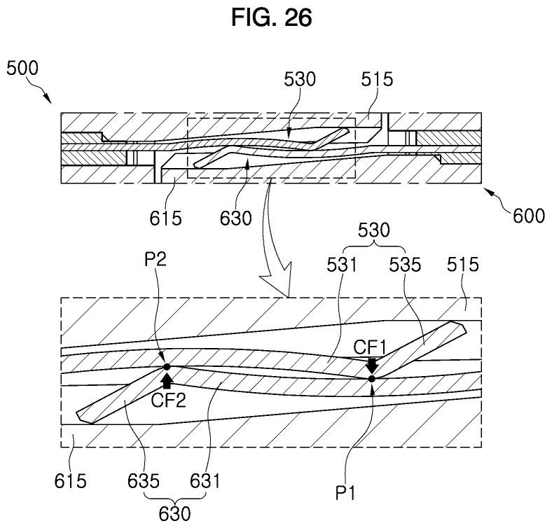

FIG. 26 shows an example of the state in which mating between the first connector 500 and the second connector 600 is completed.

Once mating between the first connector 500 and the second connector 600 is completed, a dual contact point region may be formed between the first contact unit 530 and the second contact unit 630 due to pressing of the second contact unit 630 of the second connector 600 and pressing of the first partition wall 515.

Since the first partition wall 515 continues to press the first head portion 535 in the state in which mating between the first connector 500 and the second connector 600 is completed, the first connection region between the first lead portion 531 and the first head portion 535 may form a first contact point P1 while contacting and pressing the second lead portion 631 of the second contact unit 630.

In addition, since the second connection region between the second lead portion 631 and the second head portion 635 still presses the first lead portion 531 of the first contact unit 530, the first lead portion 531 may contact the second connection region between the second lead portion 631 and the second head portion 635, forming a second contact point P2.

Furthermore, upon completion of mating between the first connector 500 and the second connector 600, pressing of the second contact unit 630 and pressing of the first partition wall 515 may maintain mating force CF1 at which the first connection region between the first lead portion 531 and the first head portion 535 contacts and presses the second lead portion 631 of the second contact unit 630. In addition, pressing of the first contact unit 530 and pressing of the second partition wall 715 may maintain mating force CF2 at which the second connection region between the second lead portion 631 and the second head portion 635 contacts and presses the first lead portion 531 of the first contact unit 530, whereby mating between the first connector 500 and the second connector 600 may be more stably maintained.

That is, upon completion of mating between the first connector 500 and the second connector 600, dual contact points, i.e., the first contact point P1 and the second contact point P2, may be formed by pressing between the first contact unit 530 and the second contact unit 630 and pressing between the first partition wall 515 and the second partition wall 615, and at the same time, the mating forces CF1 and CF2 may be maintained at the first contact point P1 and the second contact point P2, thereby enhancing the reliability of the dual contact points while simultaneously further increasing the mating stability and robustness between the connectors.

In accordance with the present disclosure described above, during mating between the connectors, a plurality of regions of the terminal may be bent by pressing of the terminal and the partition wall of the mating connector, whereby it is possible to form multiple contact points.

Furthermore, in accordance with the present disclosure, the type of the connector, such as the plug connector, the receptacle connector, or the hermaphroditic connector, may be selectively determined through the combination and arrangement relationship of the lead frame assembly.

As a result, it is possible to simplify the structural design for each connector type while enabling compatibility of the lead frame assembly, thereby reducing manufacturing and maintenance costs.

As is apparent from the above description, in accordance with the present disclosure, during mating between connectors, a plurality of regions of a terminal may be bent by pressing of a terminal and a partition wall of the mating connector, whereby it is possible to form multiple contact points.

Furthermore, upon completion of mating between the connectors, it is possible to enhance the reliability of dual contact points due to pressure applied to a contact region between contact units, and at the same time the pressure applied to the contact point may act as mating force, whereby it is possible to further increase the mating stability and robustness between the connectors.

In addition, in accordance with the present disclosure, the type of a connector, such as a plug connector, a receptacle connector, or a hermaphroditic connector, may be selectively determined through the combination and arrangement relationship of a lead frame assembly.

As a result, it is possible to simplify the structural design for each connector type while enabling compatibility of the lead frame assembly, thereby reducing manufacturing and maintenance costs.

The effects of the present disclosure are not limited to the aforementioned effects, and other unmentioned effects will be clearly understood by a person having ordinary skill in the art to which the present disclosure pertains from the above description.

The above description is merely an exemplary description of the technical ideas of the present disclosure, and a person having ordinary skill in the art to which the present disclosure pertains will be able to make various modifications and variations without departing from the essential features of the present disclosure. Therefore, the embodiments of the present disclosure are intended to show, not to limit, the technical ideas of the present disclosure, and the technical ideas of the present disclosure are not limited by the embodiments. The scope of protection of the present disclosure shall be construed in accordance with the following claims, and all technical ideas within the scope thereof shall be construed as falling within the scope of right of the present disclosure.

What is claimed is:

1. A connector comprising:
a contact unit comprising a lead portion configured such that a part of the lead portion forming a contact point with a mating terminal extends straight without bending and a head portion bent from the lead portion toward a partition wall, the head portion extending straight; and
wherein the partition wall is provided so as to correspond to the contact unit, the partition wall being configured to provide a space configured to support the contact unit,
wherein a connection region between the head portion and the lead portion is bent in one direction by pressing of the mating terminal and pressing of the partition wall due to mating with a mating connector, thereby forming a first contact point in contact with the mating terminal, and a part of the lead portion is bent in the other direction, thereby forming a second contact point in contact with the mating terminal.

2. The connector as claimed in claim 1, comprising a lead frame assembly comprising:
a terminal comprising the contact unit configured to form a contact point with the mating terminal, a mounting portion mounted to a substrate, and a signal transmission line portion configured to connect the contact unit and the mounting portion to each other; and
a frame body in which signal transmission line portions of a plurality of terminals are arranged and assembled or molded, the frame body being configured to support a plurality of contact units, the plurality of contact units being arranged in the one direction to form a contact array.

3. The connector as claimed in claim 2,
wherein the lead frame assembly comprises an A-type lead frame assembly configured such that the head portion is bent relative to the lead portion in a first direction and a B-type lead frame assembly configured such that the head portion is bent relative to the lead portion in a second direction opposite the first direction, and
wherein the A-type lead frame assembly and the B-type lead frame assembly are alternately disposed.

4. The connector as claimed in claim 3,
wherein a type of the connector is determined as any one of a plug connector, a receptacle connector, and a hermaphroditic connector based on a combination and arrangement sequence of the A-type lead frame assembly and the B-type lead frame assembly.

5. The connector as claimed in claim 3,
wherein the A-type lead frame assembly and the B-type lead frame assembly of the lead frame assembly are alternately arranged in plural, and
the connector comprises a header housing in which the partition wall is provided so as to correspond to the A-type lead frame assembly and the B-type lead frame assembly which are alternately disposed and into which a part of a front end of each of the A-type lead frame assembly and the B-type lead frame assembly which are alternately disposed is inserted and mounted.

6. A connector system comprising:
a first connector comprising:
a first contact unit comprising:
a first lead portion configured such that a part of the first lead portion forming a contact point with a mating terminal extends straight without bending, and
a first head portion bent from the first lead portion toward a first partition wall and extending straight,
wherein the first partition wall is provided so as to correspond to the first contact unit and is configured to provide a space configured to support the first contact unit; and
a second connector comprising a second contact unit in contact with the first contact unit,
wherein upon mating between the first connector and the second connector, the first contact unit is bent by pressing the second contact unit and pressing the first partition wall, thereby forming dual contact points with the second contact unit.

7. The connector system as claimed in claim 6,
wherein the second contact unit comprises a second lead portion configured such that a part of the second lead portion forming a contact point with the first contact unit extends straight without bending and a second head portion bent from the second lead portion toward a second partition wall, the second head portion extending straight, and
wherein the first contact unit and the second contact unit are mirror images of each other symmetrical about a mating axis.

8. The connector system as claimed in claim 7,
wherein, in an initial mating state between the first connector and the second connector, the second lead portion of the second contact unit is located in a space formed by extending a distance between an upper end surface of the first lead portion and the first partition wall.

9. The connector system as claimed in claim 7,
wherein a connection region between the first lead portion and the first head portion contacts and presses the second lead portion to form a first contact point, and
wherein a connection region between the second lead portion and the second head portion contacts and presses the first lead portion to form a second contact point.

10. The connector system as claimed in claim 8,
wherein a pressing force generated when a connection region between the first lead portion and the first head portion contacts and presses the second lead portion and a pressing force generated when a connection region between the second lead portion and the second head portion contacts and presses the first lead portion act as a mating force between the first connector and the second connector.

11. A connector mating method comprising:
an initial contact unit contact step of a first head portion of a first contact unit of a first connector and a second head portion of a second contact unit of a second connector coming into contact with each other to press each other;
a top dead center arrival step of a first connection region between a first lead portion and the first head portion of the first contact unit and a second connection region between a second lead portion and the second head portion of the second contact unit contacting and pressing each other, whereby the first contact unit and the second contact unit reach a top dead center of bending deformation; and
a dual contact point formation step of the first connection region of the first contact unit contacting and pressing the second lead portion of the second contact unit due to a first partition wall pressing the first head portion of the first contact unit to form a first contact point and the second connection region of the second contact unit contacting and pressing the first lead portion of the first contact unit due to a second partition wall pressing the second head portion of the second contact unit to form a second contact point.

12. The connector mating method as claimed in claim 11, further comprising:
an initial connector mating step of the second lead portion of the second contact unit being located in a space formed by extending a distance between an upper end surface of the first lead portion of the first contact unit and the first partition wall and the first lead portion of the first contact unit being located in a space formed by extending a distance between an upper end surface of the second lead portion of the second contact unit and the second partition wall.

13. The connector mating method as claimed in claim 11,
wherein, in the initial contact unit contact step, the first head portion of the first contact unit and the second head portion of the second contact unit slide along inclined surfaces of each other due to pressing between the first head portion and the second head portion, whereby the first lead portion of the first contact unit and the second lead portion of the second contact unit are bent in a curved shape in directions toward the first partition wall and the second partition wall, respectively, and the first head portion of the first contact unit and the second head portion of the second contact unit contact and press each other due to the first partition wall and the second partition wall.

14. The connector mating method as claimed in claim 11, further comprising:
a mating continuation step of, as the first connection region of the first contact unit and the second connection region of the second contact unit pass each other and move toward the second lead portion and the first lead portion, respectively, the first connection region of the first contact unit and the second connection region of the second contact unit protruding and moving toward the second lead portion and the first lead portion, respectively, due to pressing of the first partition wall and the second partition wall, thereby contacting and pressing the second lead portion and the first lead portion, respectively.

15. A connector comprising:
a plurality of lead frame assemblies comprising a contact array in which a plurality of contact units are arranged in one direction,
wherein each contact unit of the plurality of contact units comprises a lead portion and a head portion bent and extending from the lead portion,
wherein the plurality of lead frame assemblies include an A-type lead frame assembly configured such that the head portion is bent relative to the lead portion in a first direction and a B-type lead frame assembly configured such that the head portion is bent relative to the lead portion in a second direction opposite the first direction, and
wherein the A-type lead frame assembly and the B-type lead frame assembly are alternately disposed.

16. The connector as claimed in claim 15,
wherein the contact unit of the A-type lead frame assembly and the contact unit of the B-type lead frame assembly are symmetrical mirror images of each other.

17. The connector as claimed in claim 15,
wherein each of the plurality of lead frame assemblies comprises:
a terminal comprising the contact unit, a mounting portion mounted to a substrate, and a signal transmission line portion configured to connect the contact unit and the mounting portion to each other; and
a frame body in which signal transmission line portions of a plurality of terminals are arranged and assembled or molded such that the plurality of contact units and a plurality of mounting portions are exposed externally.

18. The connector as claimed in claim 15,
wherein a type of the connector is determined as any one of a plug connector, a receptacle connector, and a hermaphroditic connector based on a combination and arrangement sequence of the A-type lead frame assembly and the B-type lead frame assembly.

19. The connector as claimed in claim 18,
wherein the plug connector is configured to have a structure in which the A-type lead frame assembly and the B-type lead frame assembly are alternately disposed such that bending directions of head portions of last two consecutively adjacent lead frame assemblies on left and right sides among the plurality of lead frame assemblies face each other.

20. The connector as claimed in claim 18,
wherein the receptacle connector is configured to have a structure in which the A-type lead frame assembly and the B-type lead frame assembly are alternately disposed such that bending directions of head portions of last two consecutively adjacent lead frame assemblies on left and right sides among the plurality of lead frame assemblies are opposite each other.

21. The connector as claimed in claim 18,
wherein the hermaphroditic connector is configured to have a structure in which the A-type lead frame assembly and the B-type lead frame assembly are alternately disposed such that bending directions of head portions of last two consecutively adjacent lead frame assemblies on any one of left and right sides among the plurality of lead frame assemblies face each other and bending directions of head portions of last two consecutively adjacent lead frame assemblies on the other of the left and right sides among the plurality of lead frame assemblies are opposite each other.

22. The connector as claimed in claim 18, further comprising:
a header housing in which a partition wall is provided so as to correspond to the A-type lead frame assembly and the B-type lead frame assembly which are alternately disposed and into which a part of a front end of each of the A-type lead frame assembly and the B-type lead frame assembly which are alternately disposed is inserted and mounted.

23. The connector as claimed in claim 22,
wherein the header housing is selected and mounted as any of the plug connector, the receptacle connector, and the hermaphroditic connector so as to correspond to the A-type lead frame assembly and the B-type lead frame assembly which are alternately disposed.
